(19) United States
(12) Patent Application Publication
(10) Pub. No.: US 2010/0045684 A1
(43) Pub. Date: Feb. 25, 2010

(54) HOST CONTROL DEVICE, SLAVE CONTROL DEVICE, SCREEN OPERATION RIGHT GIVING METHOD, AND STORAGE MEDIUM CONTAINING SCREEN OPERATION RIGHT GIVING PROGRAM

(75) Inventor: Munetaka Yamagami, Amagasaki-City (JP)

Correspondence Address: CANTOR COLBURN, LLP, 20 Church Street, 22nd Floor, Hartford, CT, 06103, US

(73) Assignee: TOKYO ELECTRON LIMITED, Tokyo (JP)

(21) Appl. No.: 12/515,204

(22) PCT Filed: Nov. 15, 2007
(86) PCT No.: PCT/JP2007/072183

§ 371 Date: May 15, 2009

(30) Foreign Application Priority Data
Nov. 16, 2006 (JP) 2006-310001

(51) Int. Cl. G06F 13/14

(52) U.S. Cl. 345/520

(57) ABSTRACT

A host personal computer (PC) 100 is connected to a plurality of slave PC 200 for controlling a plurality of process modules (PM) or a transfer module (TM). The host PC 100 judges whether or not an operation right is given to the slave PC 200 which has requested the operation right in accordance with the screen operation request from the slave PC 200.

### TECHNICAL FIELD

The present invention relates to a host control device for controlling the giving of an operation right of a screen group displayed on a display unit of a slave control device for controlling a substrate processing device or a transfer device, a slave control device for requesting a screen operation, a screen operation right giving method, and a storage medium containing a screen operation right giving program.

### BACKGROUND ART

Conventionally, there is provided a system for remotely controlling substrate processes using a host PC by disposing a plurality of substrate processing devices for performing predetermined processes with respect to a substrate and a transfer device for transferring the substrate in a clean room, mounting a slave Personal Computer (PC) for controlling the plurality of substrate processing devices and the transfer device in the vicinity of each of the devices in the clean room, and mounting the host PC outside the clean room such that the host PC and the slave PC transmit or receive information to or from each other via a network. According to this system, by the remote operation using the host PC, it is possible to minimize entrance and exit of a person with respect to the clean room and minimize the contamination of the clean room.

In such a remote control system, the display unit of the host PC and the display unit of the slave PC share the same screen group so as to perform a display operation. During a normal operation, the host PC has a screen operation right but, in a special situation, that is, if abnormality occurs in the devices in the clean room, the same screen operation right is temporarily transferred from the host PC to the slave PC (for example, see Japanese Unexamined Patent Application Publication No. 2004-348605).

### DISCLOSURE OF THE INVENTION

### Problems to be Solved by the Invention

However, according to the conventional system, the screen operation right is transferred to either the host PC or the slave PC, but the number of PCs having the screen operation right is limited to one. Accordingly, if one PC has the operation right, the screen displayed on the other PC cannot be operated using the other PC. Although the request for the screen operation to the other PC is notified, an operator should wait for a long time until the screen operation right is transferred to the other PC. Accordingly, efficiency is poor.

In addition, recently, the number of substrate processing devices included in a system having a cluster structure tends to be increased. Accordingly, the number of slave PCs other than the PC having the screen operation right has been increased. Even when the screen is desired to be operated by any slave PC, the slave PC needs to wait for a long time until the screen operation right is transferred to the slave PC. As a result, the operator should inconveniently go to a place where the PC (generally, the host PC) having the screen operation right is located and operate the screen of the PC.

In particular, in a previous step of transferring the system introduced in a factory to a stable mass production system, if each of the devices (each of the substrate processing devices or the transfer device) in the clean room functions as an evaluator, for example, various troubles such as collision of the substrate with the transfer device may occur in each of the devices. In this case, the operation of each of the devices may be conveniently and efficiently controlled while checking the state of each of the devices, by operating the screen of the slave PC disposed in the vicinity of each of the devices, rather than the remote operation using the host PC.

Accordingly, the present invention provides a host control device for controlling whether or not an operation right of a specific screen group is given to a slave control device for requesting a screen operation, a slave control device for requesting a screen operation, a screen operation right giving method, and a storage medium containing a screen operation right giving program.

### Means for Solving the Problems

That is, in order to solve the above-described problems, according to an embodiment of the present invention, there is provided a host control device which is connected to a first slave control device including a display unit for displaying a screen group for operating a substrate processing device and a second slave control device including a display unit for displaying a screen group for operating a transfer device via a network, includes a display unit for displaying the screen group displayed on the display unit of the first slave control device and the screen group displayed on the display unit of the second slave control device, and controls the first slave control device and the second slave control device.

This host control device includes a screen database storing the screen group displayed on the display unit of the first slave control device and the screen group displayed on the display unit of the second slave control device, a screen specifying unit specifying a screen group, of which the operation is requested, from a plurality of screen groups stored in the screen database, according to the request for a screen operation transmitted from either the first slave control device or the second slave control device, an operation right judgment unit judging whether or not the operation right of the screen group specified by the screen specifying unit is given to the requesting slave control device, and an operation right giving unit giving the operation right of the specified screen group to the requesting slave control device without changing devices to which the operation rights of screen groups other than the specified screen group are given, in order to allow different control devices of a plurality of control devices including the first slave control device, the second slave control device and the host control device to simultaneously and separately operate different screen groups, if it is judged that the operation right of the screen group is given to the requesting slave control device by the operation right judgment unit.

Accordingly, the host control device judges whether or not the operation right of the screen is given to the screen group of which the operation is requested. Accordingly, it is possible to give the operation right of the screen group, of which the operation is requested, to the requesting slave control device without the devices to which the operation rights of the screen groups other than the screen group of which the operation is requested by the slave control device are given. As this result, an operator can operate the screen of the slave control device with respect to the slave control device which has requested the operation so as to control the device while checking the state of a device in which a trouble occurs, and remotely operate the screen of the host control device with respect to other devices so as to collectively control the whole system.

In this way, the operator can simultaneously and separately operate different screen groups using two or more different control devices of the plurality of control devices including the first slave control device, the second slave control device and the host control device. Accordingly, it is possible to solve the problem in which the number of control devices capable of operating the screen is limited to one and thus the screen cannot be freely operated using its own control device when other control device is desired to be operated and provide a system with high operability to a user.

The operation right judgment unit may judge that the operation right of the specified screen group is given to the requesting slave control device after a process which is being executed by the control device to which the operation right is given is finished, if the operation right of the specified screen group is given to a control device other than the requesting slave control device in the plurality of control devices.

In addition, the operation right judgment unit may judge that the requested operation right of the screen group is given to the host control device after a process which is being executed by any one of the slave control devices is finished, if the operation right of the screen group of which the operation is requested by the host control device is given to any one of the slave control devices.

According to these judging methods, only the operation right judgment unit of the host control device can judge whether or not the operation right of the screen is given. Accordingly, for example, it is possible to eliminate a system problem which may occur when the giving of the operation right is controlled by the plurality of control devices, such as deadlock which occurs when the operation of the same screen group is substantially simultaneously requested from a plurality of control devices. As this result, it is possible to improve user ability without deteriorating the stability of a control system for controlling a substrate process having a highest degree of importance as an original operation.

Accordingly, since the operator can more efficiently operate the screen and can flexibly operate the screen by the host control device or the slave control device according to the change of the peripheral situation, it is possible to reduce operation errors. As this result, it is possible to improve the productivity of a product.

The operation right judgment unit may judge that the requested operation right of the screen group is sequentially given from a control device having a highest priority of the plurality of control devices according to predetermined priorities, if the operation of the same screen group is requested by the plurality of control devices.

The operation right judgment unit may judge whether or not the giving of the operation right to the control device which has requested the operation is inhibited in advance, and judges that the operation right is not given to the control device which has requested the operation if the giving of the operation right is inhibited.

Accordingly, it can be judged whether or not the requested operation right of the screen group is given to the requested control device according to the predetermined condition. For example, if the host control device and the slave control device request the operation of the same screen group at the substantially same timing, the requested operation right of the screen group can be preferentially given to the host control device by setting the priority of the host control device to be higher than that of the slave control device in advance.

As this result, for example, if a trouble occurs in any one substrate processing device, the operator can operate the device while checking the state of the substrate processing device using the screen of the slave control device disposed in the vicinity of the substrate processing device in which the trouble occurs. Since the screen groups other than the screen group of which the operation is requested can be operated by another control device (generally, the host control device) without changing the devices to which the operation rights are given, it is possible to remarkably reduce the standby time of the operation of the operator who operates the control devices.

The host control device may further include an input unit receiving information which is input using the screen displayed on the display unit of the host control device to which the operation right is given, if the operation right is given to the host control device by the operation right giving unit, a communication unit receiving information, which is input using the screen displayed on the display unit of the slave control device to which the operation right is given, from the slave control device to which the operation right is given, if the operation right is given to any one of the slave control devices by the operation right giving unit, a storage unit storing recipes defining a plurality of substrate processing procedures executed by the substrate processing device, and a process execution control unit executing a predetermined process executed based on the information received by the communication unit concurrently with another predetermined process executed based on the input information received by the input unit, based on the recipes stored in the storage unit.

Accordingly, if the host control device has the operation right of any screen group, a predetermined process is performed with respect to the substrate according to the processing procedure according to input information, based on the information input from the screen of the host control device. In addition, if the slave control device has the operation right of another screen group, the host control device receives the information input from the screen of the slave control device such that another predetermined process is performed according to the processing procedure according to the received information.

Since the input operation to the screen is validated by only the control device having the operation right and the operation right of each screen group is given to any one control device, the operator can simultaneously and separately operate different screen groups displayed on different control devices.

All the substrate processes performed based on the valid input operation to the screen are controlled by the host control device. That is, the host control device controls the processes using the recipes defining the processing procedures, and the slave control device drives the device based on the command of the host control device.

Accordingly, the process execution control unit of the host control device can control a plurality of processes to be concurrently executed based on information (information received from the slave control device or information input to the host control device) instructed from the plurality of control devices having the operation rights. In addition, by controlling all the substance processes by the host control device regardless of possession/non-possession of the operation right of the screen, it is possible to avoid mismatching of data for performing the processes and stably operate the system.

In addition, examples of the predetermined process include an organic electroluminescence (EL) deposition film process, a Chemical Vapor Deposition (CVD) process, an etching process and a sputtering process as the substrate process executed by the substrate processing device and include a substrate transferring process as the process executed by the transfer device.

The display unit of the host control device may update the contents of the screen displayed on the display unit of the host control device so as to keep a matching property with the contents of the screen displayed on the display unit of the slave control device to which the operation right is given, based on the information received by the communication unit in correspondence with the input operation to the screen displayed on the display unit of the slave control device to which the operation right is given.

Accordingly, it is possible to keep a matching property of the contents of the display screen of the host control device and the contents of the display screen of the slave control device to which the operation right is given.

The display unit of the host control device may not display the screen group if the operation right is given to any one of the slave control devices and the screen group of which the operation right is given is inhibited from being displayed on the display unit of the host control device in advance.

Accordingly, the screen group of which the operation right is given to any slave control device is not displayed on the screens of the host control device and the other slave control devices. Accordingly, it is possible to prevent important information from flowing out by displaying the important information on the screen of the control device which does not have the operation right.

The host control device may be connected to a plurality of first slave control devices for controlling a plurality of substrate processing devices and is connected to the second slave control device for controlling a transfer device for transferring the substrate adjacent to the plurality of substrate processing devices, the screen database may manage a plurality of screen groups displayed on the display units of the plurality of first slave control devices and the screen group displayed on the display unit of the second slave control device according to the screen groups, the storage unit may manage the plurality of substrate processing procedures executed by the plurality of substrate processing devices according to the recipes, the operation right giving unit may give the operation right of the screen to any one of the plurality of control devices according to the screen groups managed by the screen database and allow different control devices to simultaneously and separately operate different screen groups, and the process execution control unit may exclusively and concurrently control the plurality of substrate processes executed by the plurality of substrate processing devices based on the recipes managed by the storage unit.

Accordingly, two or more control devices including the plurality of first slave control devices can simultaneously and separately operate different screen groups. In addition, two or more processes of the plurality of substrate processes executed by the plurality of substrate processing devices and the transfer process executed by the transfer device can be concurrently and exclusively controlled based on the processing procedures managed by the storage unit.

The plurality of first slave control devices may be disposed in the vicinities of the plurality of substrate processing devices in a room in which the plurality of substrate processing devices are disposed, the second slave control device may be disposed in the vicinity of the transfer device disposed adjacent to the plurality of substrate processing devices in the same room as the room in which the plurality of substrate processing devices are disposed, and the host control device may be disposed outside the room so as to transmit or receive information to or from the slave control devices such that the plurality of substrate processes executed by the plurality of substrate processing devices and the transfer process executed by the transfer device are controlled and the giving of the operation right of the screen group displayed on the display unit of each slave control device is controlled.

Accordingly, the plurality of substrate processing devices and the transfer device are, for example, disposed in a clean room, the plurality of slave control devices for controlling the plurality of substrate processing devices and the transfer device are disposed adjacent to a device to be controlled in the clean room, and the host control device is disposed outside the cleaning room. The host control device and the slave control device transmit or receive information to or from each other using the network such that the devices in the clean room can be remotely operated using the host control device. Accordingly, it is possible to minimize entrance and exit of a person with respect to the clean room and minimize the contamination of the clean room.

In addition, according to such a configuration, the host control device has the operation right of the screen during a normal operation, and only the operation right of a specified screen group is transferred from the host control device to the slave control device in a special situation, that is, if a trouble occurs in the substrate processing device in the clean room. Accordingly, the operator can operate the device, in which the trouble occurs, while checking the state of the device, in which the trouble occurs, using the screen of the slave control device, to which the operation right is given, and operate the screen of the host control device so as to remotely control other devices.

In addition, in order to solve the above-described problems, according to another aspect of the present invention, there is provided a slave control device which is connected to a host control device for controlling an operation right of a screen via a network and includes a display unit for displaying either a screen group for operating a substrate processing device or a screen group for operating a transfer device, the device including: a screen database storing the screen group displayed on the display unit of the slave control device; an operation right requesting unit generating information for requesting the operation right of the screen group stored in the screen database; and a communication unit transmitting the operation right request information generated by the operation right requesting unit to the host control device so as to request the operation of the screen and transmitting information, which is input using the display screen of the slave control device to which the operation right is given, to the host control device if the operation right of the screen group of which the operation is requested is given to the slave control device by the host control device, without changing devices to which the operation rights of screen groups other than a screen group specified according to the transmitted operation right request information are given, wherein a predetermined process executed based on the information transmitted from the slave control device to which the operation right is given is executed by the host control device concurrently with another predetermined process executed based on the information input using the screen displayed on the display unit of the host control device.

Accordingly, it is possible to give the operation right of the screen group, of which the operation is requested, to the requesting slave control device (without changing the devices to which the operation rights of the screen groups other than the requested screen group are given), according to the request for the operation from the slave control device.

In addition, in order to solve the above-described problems, according to another aspect of the present invention, there is provided a screen operation right giving method using a host control device which is connected to a first slave control device including a display unit for displaying a screen group for operating a substrate processing device and a second slave control device including a display unit for displaying a screen group for operating a transfer device via a network, includes a display unit for displaying the screen group displayed on the display unit of the first slave control device and the screen group displayed on the display unit of the second slave control device, and controls the first slave control device and the second slave control device, the method including: storing the screen group displayed on the display unit of the first slave control device and the screen group displayed on the display unit of the second slave control device in a screen database; specifying a screen group, of which the operation is requested, from a plurality of screen groups stored in the screen database, according to a request for the operation of the screen transmitted from either the first slave control device or the second slave control device; judging whether or not the operation right of the specified screen group is given to the requesting slave control device; and giving the operation right of the specified screen group to the requesting slave control device without changing devices to which the operation rights of screen groups other than the specified screen group are given, in order to allow different control devices of a plurality of control devices including the first slave control device, the second slave control device and the host control device to simultaneously and separately operate different screen groups, if it is judged that the operation right of the screen group is given to the requesting slave control device.

In addition, in order to solve the above-described problems, according to another aspect of the present invention, there is provided a storage medium containing a screen operation right giving program for executing a process of giving an operation right of a screen on a computer using a host control device which is connected to a first slave control device including a display unit for displaying a screen group for operating a substrate processing device and a second slave control device including a display unit for displaying a screen group for operating a transfer device via a network, includes a display unit for displaying the screen group displayed on the display unit of the first slave control device and the screen group displayed on the display unit of the second slave control device, and controls the first slave control device and the second slave control device, the screen operation right giving program executing on the computer a method including: storing the screen group displayed on the display unit of the first slave control device and the screen group displayed on the display unit of the second slave control device in a screen database; specifying a screen group, of which the operation is requested, from a plurality of screen groups stored in the screen database, according to a request for the operation of the screen transmitted from either the first slave control device or the second slave control device; judging whether or not the operation right of the specified screen group is given to the requesting slave control device; and giving the operation right of the specified screen group to the requesting slave control device without changing devices to which the operation rights of screen groups other than the specified screen group are given, in order to allow different control devices of a plurality of control devices including the first slave control device, the second slave control device and the host control device to simultaneously and separately operate different screen groups, if it is judged that the operation right of the screen group is given to the requesting slave control device.

### Effect of the Invention

As described above, according to the present invention, it is possible to give the operation right of a specified screen group to a control device which has requested the operation of the screen.

### BEST MODE FOR CARRYING OUT THE INVENTION

Hereinafter, the exemplary embodiments of the present invention will be described in detail with reference to the accompanying drawings. In the following description and the accompanying drawings, the components having the same configuration and function are denoted by the same reference numerals and the repeated description will be omitted.

### First Embodiment

First, a substrate processing system according to a first embodiment of the present invention will be described with reference to FIGS. 1 and 2. FIG. 1 is a schematic view of the substrate processing system and FIG. 2 is an arrangement view of devices configuring the substrate processing system.

(Substrate Processing System)

The substrate processing system 10 includes a host Personal Computer (PC) 100, slave PCs 200a to 200e, a transfer module TM, and process modules PM1 to PM4. These devices are connected by, for example, a network 300 such as Ethernet (registered trademark). In addition, the host PC 100 is connected to a host computer 500 via a Local Area Network (LAN) 400.

As shown in FIG. 2, the slave PCs 200b to 200e (corresponding to a plurality of first slave control devices) are disposed in a clean room Cln, in which the process modules PM1 to PM4 are disposed, in the vicinities of the process modules PM1 to PM4. The slave PC 200a (corresponding to a second slave control device) is disposed in the clean room Cln in the vicinity of the transfer module TM disposed on the central portion of the process module PM.

The host PC (corresponding to a host control device) is disposed outside the clean room Cln. The host PC 100 transmits or receives a control signal to or from the slave PC 200 so as to remotely control the transfer module TM and the process modules PM1 to PM4. In more detail, the host PC 100 remotely operates a process of transferring a substrate by the transfer module TM and remotely operates desired processes performed by the process modules PM1 to PM4. Accordingly, it is possible to minimize entrance and exit of a person with respect to the clean room and minimize the contamination of the clean room. The host PC 100 may be disposed in the clean room Cln.

The slave PCs 200a, 200b, 200c, 200d and 200e respectively include a display 200aSD, a display 200bSD, a display 200cSD, a display 200dSD and a display 200eSD to display a screen group for operating the transfer module TM, a screen group for operating the process module PM1, a screen group for operating the process module PM2, a screen group for operating the process module PM3, and a screen group for operating the process module PM4. The host PC 100 includes a display 100MD to display the screen groups displayed on the displays 200SD of the slave PCs 200b to 200e.

Sensors TMs, PM1s, PM2s, PM3s and PM4s for detecting the states of the internal devices are attached to the transfer module TM and the process modules PM1 to PM4, and the detected values thereof are respectively input to their safety Programmable Logic Controllers (PLCs). Each of the safety PLCs corresponds to a safety-authenticated software interlock device which can program interlock conditions established in conventional hardware (safety circuit) and perform a control operation in software.

A control signal transmitted from the host PC 100 is also input to the safety PLCs. Each of the safety PLCs receives the control signal and a detection signal representing the detected value from each of the sensors, and controls an output signal not to be transmitted to the slave PC 200 if the received signal satisfies any one of predetermined interlock conditions. Accordingly, the slave PC 200 can avoid a false operation generated by driving the device in each of the modules TM and PM1 to PM4 using a false output signal satisfying the interlock conditions as a driving signal, for example, an error in a timing for supplying gases, which are dangerous if mixing, or an error in a timing for transferring a substrate. As a result, the device in the transfer module TM or the process module PM can be protected and safety of an operator in a factory can be secured.

The host computer 500 transmits or receives data to or from the host PC 100 so as to manage the whole substrate processing system 10, that is, to perform data management.

In addition, the transfer module TM corresponds to a transfer device for transferring a substrate and the process modules PM1 to PM4 correspond to substrate processing devices for performing predetermined processes with respect to the substrate. Examples of the predetermined processes executed by the process modules PM include a sputtering process executed by a sputter device in the process module PM1, an etching process executed by an etcher device in the process module PM2, a film forming process executed by a Chemical Vapor Deposition (CVD) device in the process module PM3, and an organic electroluminescence (EL) evaporation film process executed by an organic EL device in the process module PM4.

(Internal Configuration of PM2)

Next, as an example of the internal configuration of each of the process modules PM1 to PM4, the process module PM2 for executing the etching process and the process module PM4 for executing a 6-layer continuous organic EL evaporation film process will be described with reference to FIGS. 3 and 4, respectively.

The process module PM2 includes a square tube shaped process container C of which a substantial central portion of a ceiling and a substantial central portion of a bottom are opened. The process container C is, for example, formed of aluminum, of which the surface is anodized.

An upper electrode 305 is disposed in the process container C at an upper side thereof. The upper electrode 305 is electrically separated from the process container C by an insulating material 310 formed on the periphery of an upper opening of the process container C. A radio frequency power source 320 is connected to the upper electrode 305 via a matching circuit 315. A matching box 325 is disposed on the periphery of the matching circuit 315 and functions as a ground casing of the matching circuit 315.

A process gas supply unit 335 is connected to the upper electrode 305 via a gas line 330. A desired gas supplied from the process gas supply unit 335 is ejected from a plurality of gas spraying holes A into the process container C. In this way, the upper electrode 305 functions as a gas shower head. A temperature sensor 340 is disposed on the upper electrode 305. The temperature sensor 340 detects the temperature of the upper electrode 305 as the internal temperature of the process container and transmits the detected value to the safety PLC.

A lower electrode 345 is disposed in the process container C at a lower portion thereof. The lower electrode 345 functions as a susceptor on which a substrate G is held. The lower electrode 345 is supported by a support 355 disposed with an insulating material 350 interposed therebetween. Accordingly, the lower electrode 345 is electrically separated from the process container C.

One end of a bellows 360 is mounted in the vicinity of the outer circumference of an opening formed in the bottom of the process container C. The other end of the bellows 360 is fixed to an elevating plate 365. By this configuration, the opening of the bottom of the process container C is hermetically sealed by the bellows 360 and the elevating plate 365. In addition, the lower electrode 345 integrally moves up and down with the bellows 360 and the elevating plate 365 in order to adjust a position where the substrate G is laid to a height corresponding to the process.

The lower electrode 345 is connected to the elevating plate 365 via a conductive path 370 and an impedance adjustment unit 375. The upper electrode 305 and the lower electrode 345 correspond to a cathode electrode and an anode electrode, respectively. The inside of the process container is depressurized to a desired vacuum degree by an exhaust mechanism 380.

By such a configuration, opening and closing of a gate valve 385 are controlled according to the driving signal transmitted from the slave PC 200c. Accordingly, in a state in which the substrate G is transferred into the process container C while keeping airtightness of the process container C, the gas supplied into the process container is made into plasma by radio frequency power and desired etching is performed with respect to the substrate G by the action of the generated plasma.

(Internal Configuration of PM4)

Next, the internal configuration of the process module PM4 for executing the 6-layer continuous organic EL evaporation film process will be described with reference to FIG. 4 which is a perspective view of main portions thereof. Six layers including an organic EL layer are continuously evaporated on the substrate G in the process module PM4.

Six evaporation sources 410a to 410f are mounted in the process module PM4. Different kinds of film forming materials are inserted into the six evaporation sources 410a to 401f, respectively. A crucible inserted into each of the evaporation sources 410 is heated to a high temperature of about 200 to 500° C. such that various kinds of film forming materials are gasified.

Six blow-out vessels 430a to 430f are connected to the six evaporation sources 410a to 410f via six connection pipes 420a to 420f, respectively. The various kinds of film forming materials gasified by the six evaporation sources 410a to 410f are blown out from openings OP (blow-out holes) formed in the upper surfaces of the six blow-out vessels 430a to 430f through the six connection pipes 420a to 420f, respectively.

Partition walls 440 are disposed between the blow-out vessels 430. The blow-out vessels 430 are divided by the seven partition walls 440 such that the gas molecules of the film forming material blown out from each of the blow-out vessels 430 are prevented from being mixed with the gas molecules of the film forming material blown out from an adjacent one of the blow-out vessels 430.

The substrate G is electrostatically adhered to a stage including a sliding mechanism (all not shown) in the vicinity of the ceiling of the process module PM4 and is moved slightly above the blow-out vessels 430a to 430f divided by the seven partition walls 440 at a predetermined speed in order of the first blow-out vessel 430a, the second blow-out vessel 430b, the third blow-out vessel 430c, the fourth blow-out vessel 430d, the fifth blow-out vessel 430e and the sixth blow-out vessel 430f. Accordingly, six desired different films are continuously laminated on the substrate G by the film forming materials blown out from the blow-out vessels 430a to 430f.

(Hardware Configuration of PC)

Next, the hardware configuration of the PC will be described with reference to FIG. 5. In addition, since the hardware configuration of the slave PC 200 is equal to that of the host PC 100, only the hardware configuration of the host PC 100 will be described herein.

The host PC 100 includes a Read Only Memory (ROM) 105, a Random Access Memory (RAM) 110, a Central Processing Unit (CPU) 115, a bus 120, an internal interface (internal I/F) 125, and an external interface (external I/F) 130.

A basic program executed by the host PC 100, a program starting in abnormality, and various kinds of recipes are recorded in the ROM 105. Various kinds of data or programs such as a screen operation right giving program defining a processing procedure for giving a screen operation right are stored in the RAM 110. In addition, the ROM 105 and the RAM 110 are the examples of a storage device, and a storage device such as an Electrically Erasable Programmable Read Only Memory (EEPROM), an optical disk, or a magnetooptical disk may be used.

The CPU 115 controls the process of the substrate according to the various kinds of recipes and controls the giving of the screen operation right. The bus 120 is a path for exchanging data between the devices such as the ROM 105, the RAM 110, the CPU 115, the internal interface 125 and the external interface 130.

The internal interface 125 receives data and outputs necessary data to a monitor or a speaker (not shown). The external interface 130 transmits or receives data to or from a device connected via the network 300.

(Functional Configuration of Host PC)

Next, the functional configuration of the host PC 100 will be described with reference to FIG. 6 which is a block diagram showing the functions of the host PC 100. The host PC 100 includes functions of a TM screen database 150, a PM screen database 155, a screen specifying unit 160, an operation right judgment unit 165, an operation right giving unit 170, an input unit 175, a communication unit 180, a storage unit 185, a process execution control unit 190 and a display unit 195.

A TM screen group (TM screen 1 to TM screen n) displayed on the display 200aSD of the slave PC 200a is stored in the TM screen database 150. A PM1 screen group displayed on the display 200bSD of the slave PC 200b, a PM2 screen group displayed on the display 200cSD of the slave PC 200c, a PM3 screen group displayed on the display 200dSD of the slave PC 200d, and a PM4 screen group displayed on the display 200eSD of the slave PC 200e are stored in the PM screen database 155. In addition, the TM screen database 150 and the PM screen database 155 correspond to a screen database for storing a screen group displayed on the display unit of the first slave control device and a screen group displayed on the display unit of the second slave control device, respectively.

The screen specifying unit 160 specifies a screen group, of which the operation is requested, from a plurality of screen groups stored in any one of the TM screen database 150 or the PM screen database 155 according to a request for the operation of the screen transmitted from any one of the slave PCs 200a to 200e.

The operation right judgment unit 165 judges whether or not the operation right of the screen group specified by the screen specifying unit 160 is given to the requesting slave PC 200. The operation right judgment unit 165 keeps judgment information 165a for judging which of the PCs has the operation right of the screen groups (the TM screen group, the PM1 screen group, the PM2 screen group, the PM3 screen group and the PM4 screen group) at a current time.

If the operation right of the specified screen group is given to a PC other than the requesting slave PC 200 in the plurality of control devices (that is, the host PC 100 and the slave PCs 200a to 200e), the operation judgment unit 165 may judge that the operation right of the specified screen group is given to the requesting slave PC 200 after a process which is being executed by that PC is finished.

In addition, if the operation of the screen is requested by the host PC 100 and the operation right of the screen group is given to any one slave PC 200, the operation right judgment unit 165 may judge that the operation right of the specified screen group is given to the host PC 100 after a process which is being executed by that slave PC 200 is finished.

In addition, if the operation of the same screen group is requested by the plurality of control devices (PCs), the operation right judgment unit 165 may judge that the requested operation right of the screen group is sequentially given according to predetermined priorities from a control device having a highest priority of the plurality of control devices (PCs).

In addition, the operation right judgment unit 165 may judge whether or not the giving of the operation right to a control device (PC) which has requested the operation is inhibited, and judge that the operation right is not given to the control device (PC) which has requested the operation if the giving of the operation right is inhibited.

If the operation right judgment unit 165 judges that the operation right of the specified screen group is given to the requesting slave PC 200 based on such judgment conditions, the operation right giving unit 170 gives the operation right of the specified screen group to the requesting slave PC 200 without changing the devices to which the operation rights of the screen groups other than the specified screen group are given. Accordingly, in the plurality of PCs including the slave PCs 200a to 200e and the host PC 100, different PCs are allowed to be simultaneously and separately operated with respect to different screen groups.

If the operation right is given to the host PC 100 by the operation right giving unit 170, the input unit 175 receives information which is input by an operator using a screen displayed on the display 100MD of the host PC 100. However, if the host PC 100 does not have the operation right of the screen group, the input information is not received. That is, the operator cannot input the information using the screen displayed by the host PC 100.

If the operation right is given to any one slave PC 200 by the operation right giving unit 170, the communication unit 180 receives information, which is input using a screen displayed on the display 200SD of the slave PC 200 to which the operation right is given, from the slave PC 200 to which the operation right is given.

The storage unit 185 stores various kinds of processing procedures of the substrate G, which are executed by the process modules PM1 to PM4. The sputtering process procedure executed by the process module PM1 is defined in a sputtering system recipe A. An etching process procedure executed by the process module PM2 is defined in an etching system recipe B. A CVD process procedure executed by the process module PM3 is defined in a CVD system recipe C. An organic EL evaporation film process procedure executed by the process module PM4 is defined in an organic EL system recipe D. Link information (for example, a process recipe name) of the process recipes A to D and a transfer route (for example, TM→PM1→TM) are defined in each of the system recipes.

The process execution control unit 190 executes a predetermined substrate process, which is received through the communication unit 180 by the screen operation of the slave PC 200 and is executed based on the information received by the host PC 100, concurrently with another predetermined process executed based on the input information received by the input unit 175 according to the screen operation of the host PC 100, based on the processing procedure stored in the storage unit 185.

The display unit 195 updates the contents of the screen displayed on the display 100MD of the host PC 100 so as to keep a matching property with the contents of the screen displayed on the display 200SD of the slave PC 200 to which the operation right is given, based on the information received by the communication unit 180 according to the input operation to the screen displayed on the display 200SD of the slave PC 200 to which the operation right is given.

In the above-described functions of the units, mainly, the process for the screen including the control of the operation right of the screen displayed by the host PC 100 and the slave PC 200 is controlled by the functions of the TM screen database 150, the PM screen database 155, the screen specifying unit 160, the operation right judgment unit 165, the operation right giving unit 170, the input unit 175 and the display unit 195 (display screen control). Meanwhile, mainly, a substrate process and a transfer process executed by the transfer module TM and the process modules PM1 to PM4 are controlled by the storage unit 185 and the process execution control unit 190 (process execution control).

In addition, the above-described functions of the units of the host PC 100 are actually accomplished by, at the CPU 115 of FIG. 5, reading a program from a storage medium, such as the ROM 105 or the RAM 110 for storing a program (including the recipes) defining the processing procedures for realizing these functions, and analyzing the program.

(Functional Configuration of Slave PC)

Next, the functional configuration of the slave PC 200 will be described with reference to FIG. 7 which is a block diagram showing the functions of the slave PC 200. The slave PC 200 includes the functions of a screen database 205, a storage unit 210, an operation right requesting unit 215, an input unit 220, a communication unit 225, a display unit 230 and a driving control unit 235.

Only the screen group displayed on the display 200SD of the slave PC 200 is stored in the screen database 205. For example, the PM1 (sputtering) screen group is stored in the screen database 205 of the slave PC 200b. The PM2 (etching) screen group is stored in the screen database 205 of the slave PC 200c. The PM3 (CVD) screen group is stored in the screen database 205 of the slave PC 200d. The PM4 (organic EL evaporation) screen group is stored in the screen database 205 of the slave PC 200e. The TM (transfer) screen group is stored in the screen database 205 of the slave PC 200a, instead of the PM screen group.

The process recipe A defining the sputtering process procedure executed by the process module PM1, the process recipe B defining the etching process procedure executed by the process module PM2, the process recipe C defining the CVD process executed by the process module PM3 and the process recipe D defining the organic EL evaporation film process executed by the process module PM4 are stored in the storage unit 210 as the process recipes defining the processing procedures of various kinds of processes executed by the process modules PM1 to PM4. As an example of the process recipe, an example of the process recipe C (CVD process) is shown in FIG. 8.

The operation right requesting unit 215 generates information (operation right request information) for requesting the operation right of the screen group stored in the screen database 205 if the slave PC does not have the operation right of a displayable screen group at a current time.

The input unit 220 receives the information which is input by the operator using the screen displayed on the display 200SD of the slave PC 200 if the operation right is given to the slave PC 200. That is, the input unit 220 inputs the input information to the slave PC 200 if the slave PC 200 has the operation right of that screen group. However, if the slave PC 200 does not have the operation right of that screen group, the input information is not received. That is, the operator cannot input the information using the screen displayed by the slave PC 200.

The communication unit 225 transmits the operation right request information generated by the operation right requesting unit 215 to the host PC 100 so as to request the screen operation, and transmits the information, which is input using the screen displayed on the display 200SD of the slave PC 200, to the host PC 100 if the operation right of the screen group of which the operation is requested is given to its slave PC 200 by the host PC 100, in accordance with the transmitted operation right request information.

The display unit 230 receives the information, which is input using the screen displayed on the display 100MD of the host PC 100 or the display 200SD of another slave PC 200 to which the operation right is given, by the communication unit 225, and updates the contents of the screen displayed on the display 200SD of the slave PC 200 so as to keep the matching property with the contents of the screen displayed on the display of the PC to which the operation right is given, based on the received information.

The driving control unit 235 generates a driving signal for driving the device in the process module PM based on the process recipe defining the processing procedure of the process module PM according to the control signal which is transmitted by the host PC 100 and is received by the communication unit 225, and transmits the driving signal to the process module. Accordingly, the process module PM performs a desired substrate process according to the instruction of the slave PC 200 corresponding to the command of the host PC 100.

In addition, similar to the host PC 100, the above-described functions of the units of the slave PC 200 are accomplished by, at the CPU of the slave PC 200, reading a program from a storage medium for storing a program (including the recipes) defining the processing procedures for realizing these functions, and analyzing the program.

(Operation of Each PC)

Next, the screen operation right giving process using the above-described functions of each PC will be described with reference to flowcharts shown in FIGS. 9 and 10. In addition, it is assumed that, in an initial state, all the operation rights of the screen groups are given to the host PC 100. FIG. 9 is a flowchart showing an operation request interrupt process executed by the slave PC 200 and FIG. 10 is a flowchart showing an operation right giving process executed by the host PC 100.

For example, if a trouble occurs in the 6-layer continuous organic EL device of the process module PM4, the operator operates the screen of the display 200eSD of the slave PC 200e disposed in the vicinity of the process module PM4 rather than the remote operation using the host PC 100, such that the operation of the process module PM4 is easily and efficiently controlled while checking the state of the process module PM4.

Accordingly, in this case, when the operator presses an operation request button displayed on the screen of the display 200eSD of the slave PC 200e, the operation request interrupt process is started from a step 900 of FIG. 9.

(Operation Request Interrupt Process)

When the input unit 220 receives the pressing of the operation request button, the operation right requesting unit 215 judges whether or not the slave PC 200e has the operation right in a step 905. If the slave PC has the operation right of the displayable screen group at this time, then the process progresses to a step 995 and the present interrupt process is finished. In contrast, if the slave PC does not have the operation right of the displayable screen group at this time, then the process progresses to a step 910 of generating the information (operation right request information) for requesting the operation right of the PM4 screen group stored in the screen database 205 and transmitting the information to the host PC 100 as the operation request interrupt signal. Then, the present interrupt process is finished in the step 995.

(Operation Right Giving Process)

As the result of the operation request interrupt process, if the operation request interrupt signal is transmitted from the slave PC 200e, the host PC 100 receives the operation request interrupt signal and starts the operation right giving process from a step 1000 shown in FIG. 10. In a step 1005, the screen specifying unit 160 specifies the screen group, of which the operation right is requested from the operation right request information of the operation request interrupt signal, as the PM4 screen group.

Next, the process progresses to a step 1010, in which the operation right judgment unit 165 judges whether or not the giving of the operation right to the slave PC 200e which has requested the operation at this time is inhibited. If the giving of the operation right is inhibited, then the process progresses to a step 1095 and the present process is finished. In contrast, if the giving of the operation right is not inhibited, the process progresses to a step 1015, in which the operation right judgment unit 165 judges whether or not the PC which has requested the operation already has the operation right of the specified screen group.

At this time, the operation right is given to the host PC 100 and the slave PC 200e does not have the operation right of the PM4 screen group. Accordingly, the process progresses to a step 1020, in which the operation right judgment unit 165 waits until a series of control processes which is being executed by the PC (at this time, the host PC 100) having the operation right of the PM4 screen group is finished. Then, if the series of control processes is finished, the process progresses to a step 1025, in which the operation right judgment unit judges that the operation right is given to the slave PC 200e which has requested the screen operation. Accordingly, the operation right giving unit 170 gives only the operation right of the PM4 screen group to the slave PC 200e in a state in which the operation rights of the screen groups other than the specified PM4 screen group, that is, the PM1 to PM3 screen groups and the TM screen, are given to the host PC 100 without changing the devices to which the operation rights of the screen groups are given, the process progresses to the step 1095, and the present process is finished. In addition, if the slave PC 200e has the operation right of the PM4 screen group, the process progresses from the step 1015 to the step 1095 and the present process is finished.

As the result of the above-described operation right giving process, as shown by the display 100MD of the host PC 100 of FIG. 11, the host PC 100 has the operation rights of the PM1 (sputtering) screen group, the PM2 (etching) screen group and the PM3 (CVD) screen group, but does not have the operation right of the PM4 (organic EL) screen group.

In this way, the operator can check to which of the PCs the operation right of the PC operated by the operator is given, by displaying the screen shown in FIG. 11 by the PC operated by the operator. In addition, as shown by the display 200eSD of the slave PC 200e of FIG. 12, the operator can check to which of the PCs the operation right of the PC operated by the operator is given, by displaying a “Client” on the left side of the screen and representing that the operation right of the PM4 (organic EL) screen group is given to the client, that is, the slave PC 200.

In this way, the host PC 100 executes the operation right giving process such that different PCs are allowed to be simultaneously and separately operated with respect to different screen groups. In more detail, as the result of the operation right giving process, the screen included in the PM1 to PM3 screen groups and the TM screen group can be operated by one operator using the display screen of the display 100MD of the host PC 100, and the screen included in the PM4 screen group can be simultaneously and separately operated by another operator using the display screen of the display 200eSD of the slave PC 200e. As this result, with respect to the process module PM4 in which a trouble occurs, the operator can operate the process module PM4 while checking the state of the process module PM4 using the screen of the slave PC 200e disposed in the vicinity of the process module PM4 without the remote operation using the screen of the host PC 100. Accordingly, the operator can more efficiently perform an operation.

In addition, according to the above-described operation right giving judging method, only the operation right judgment unit 165 of the host PC 100 can judge whether or not the operation right of the screen is given, but the slave PC 200 cannot arbitrarily give the operation right. Accordingly, for example, it is possible to eliminate a system problem which may occur when the giving of the operation right is controlled by the plurality of PCs, such as deadlock which occurs when the operation of the same screen group is substantially simultaneously requested from a plurality of PCs. As this result, it is possible to improve user ability while stably controlling the substrate process of the process module PM having a highest degree of importance as an original operation.

Accordingly, since the operator can more efficiently operate the screen and can flexibly operate the screen by the host PC 100 or the slave PC 200 according to the change of the peripheral situation, it is possible to reduce operation errors. As this result, it is possible to improve stability of a control system for controlling the substrate process of the process module PM and improve the productivity of a product.

In addition, for example, if a PC to which the operation right is not desired to be given is specified in advance, it is possible to prevent the giving of the requested operation right of the screen group to the inhibited PC in the step 1010 of FIG. 10.

In addition to the judgment condition shown in the step 1010, it may be judged whether or not the operation right of the requested screen group is given to the requested PC, according to the following predetermined conditions.

For example, if the host PC 100 and the slave PC 200 have requested the operation of the same screen group at the substantially same time, the requested operation right of the screen group may be given to the slave PC 200 having the high priority by setting the priority of the slave PC 200 to be higher than that of the host PC 100 in advance.

As a result, for example, if a trouble occurs in any one process module PM, the operator can perform the operation while checking the state of the process module PM using the screen of the slave PC 200 having the high priority and disposed in vicinity of the process module PM.

In addition, the operation right giving process of FIG. 10 is also applied to the case where the host PC 10 requests the operation right. In this case, the operation right judgment unit 165 judges whether the operation right of the screen group of which the operation is requested by the host PC 100 is given to any one slave PC 200 in the step 1015, waits until the series of processes which is being executed by the PC is finished in the step 1020 if any one slave PC 200 has the operation right, and judges that the operation right is given to the host PC 100 in the step 1025 if the series of processes is finished. Accordingly, the operation right giving unit 170 gives the operation right to the host PC 100.

In the present embodiment, according to the above-described interrupt process, it is possible to simultaneously operate different screen groups and perform the exclusive control of the substrate process executed in the process module PM1. Next, the exclusive control when this process is executed will be described with reference to the flowcharts of FIGS. 13 and 14. FIG. 13 is a flowchart showing a process execution control information input process executed by the slave PC 200 and FIG. 14 is a flowchart showing a process execution control process executed by the host PC 100.

By the executed interrupt process, at the current time, the slave PC 200e has the operation right of the PM4 screen group. In addition, the operation rights of the other PM screen groups are kept by the host PC 100. According to this situation, when the operator operates the screen of the slave PC 200e, the process execution information input process is started from a step 1300 of FIG. 13.

(Process Execution Control Information Input Process)

Next, in a step 1305, the input unit 220 determines whether or not the slave PC has the operation right. At this time, since the slave PC 200e has the operation right of the PM4 screen displayed on the display 200eSD, the process progresses to a step 1310 of receiving the input information using the PM4 screen displayed on the display 200eSD of the slave PC. Next, the process progresses to a step 1315, the communication unit 225 transmits the input information to the host PC 100, the process progresses to a step 1395, and the present process is finished.

In contrast, if the slave PC does not have the operation right, the process directly progresses from the step 1305 to the step 1395 and the present process is finished. As this result, if the slave PC has the operation right, the operation of the screen of the slave PC 200e by the operator is received and is input to the PC as input information. In contrast, if the slave PC has the operation right, the operation of the screen of the slave PC 200e by the operator is not received and the input information is discarded.

(Process Execution Control Process)

In contrast, if the input information is transmitted from the slave PC 200e, the host PC 100 starts the process execution control process from a step 1400 of FIG. 14. In a step 1405, the operation right judgment unit 165 judges whether or not the PC (host PC 100) has the operation right.

At this time, the slave PC 200e has the operation right of the PM4 screen group. Accordingly, the process progresses to a step 1410, in which the communication unit 180 judges whether or not the input information is received from any one slave PC 200 having the operation right.

At this time, the host PC 100 executes the process execution input process of FIG. 13 so as to receive the information transmitted from the slave PC 200e. Accordingly, the process progresses to a step 1415, in which the process execution control unit 190 selects the PM4 (organic EL) system recipe D from the system recipes stored in the storage unit 185, based on the information transmitted from the slave PC 200e. Next, the process progresses to a step 1420, in which the process execution control unit 190 generates a control signal for performing the 6-layer continuous organic EL evaporation film forming process with respect to the substrate G based on the process recipe D in the process module PM4 while the substrate G is transferred in order of the transfer module TM, the process module PM4 and the transfer module TM according to the system recipe D, and transmits the generated control signal to a slave PC 200. Then, the process progresses to the step 1495 and the present process is finished.

In contrast, the host PC 100 has the operation rights of the screen groups other than the PM4 screen group. Accordingly, it is judged that the PC (host PC 100) has the operation rights of the screen groups other than the PM4 screen group in the step 1405, and the process progresses to a step 1425. The input unit 175 receives the information which is input by the operator using the screens of the screen groups displayed on the display 100MD of the host PC 100 in the step 1425, and the process progresses to the step 1415. The process execution control unit 190 selects the PM system recipe from the system recipes stored in the storage unit 185 based on the input information from the screen of the host PC 100 in the same step. Next, the process progresses to a step 1420, in which the process execution control unit 190 generates a control signal for performing a desired process with respect to the substrate G according to the selected system recipe and transmits the generated control signal to the slave PC 200. Then, the process progresses to the step 1495 and the present process is finished.

(Driving Control Process)

If the control signal is transmitted from the host PC 100, the slave PC 200 starts the driving control process from a step 1500 of FIG. 15. In a step 1505, the driving control unit 235 judges whether or not the control signal is received from the host PC 100.

If the control signal is not received, the process directly progresses to a step 1595 and the present process is finished. At this time, since the control signal is received from the host PC 100, the process progresses to a step 1510, in which the driving control unit 235 selects a process recipe from the storage unit 210 based on the control signal. Then, the process progresses to a step 1515, of transmitting the driving signal to the device in the process module PM according to the selected process recipe, driving the device, and executing a desired process in the process module PM.

As described above, according to the present embodiment, the input operation to the screen is validated by only the PC having the operation right. In addition, the operation right of each screen group is given to any one PC. Accordingly, in the present embodiment, the plurality of different PCs can simultaneously and separately perform the input operation with respect to different screen groups.

The reason why the different screen groups can be simultaneously operated by the different PCs is because the screen groups displayed on the displays (the display 100MD and the display 200SD) shown in FIG. 6 are managed by the screen databases 150 and 155 of the host PC 100 and the screen database 205 of the slave PC 200 according to the screen groups, and the substance processes (the TM process, the PM1 process, the PM2 process, . . . , and the PMn process) are also managed by the storage unit 185 of the host PC 100 and the storage unit 210 of the slave PC 200 according to the kinds of processes. Accordingly, as shown by a “lateral division line” of FIG. 16, the substance process and the screen process are divided and the screen operation of each screen group is managed such that the operation right giving unit 170 gives the operation right to each screen group. Accordingly, the simultaneous operation of the screen groups can be realized.

Meanwhile, all the substance processes of the substrate G are executed by the host PC 100. This is realized by allowing the storage unit 185 of the host PC 100 and the storage unit 210 of the slave PC 200 to modularize the processing procedures of the substrate according to the kinds of the processes so as to manage the module, as described above. That is, as shown by a “longitudinal division line” of FIG. 16, the host PC 100 controls the process by separately utilizing the modularized processing procedures, and the slave PC 200 drives the device in the process module PM by the process recipe defining the processing procedure based on the command of the host PC 100.

Accordingly, the process execution control unit 190 of the host PC 100 may operate the plurality of PCs having the operation rights and exclusively and concurrently execute the plurality of processes based on the input information (that is, the information received from the slave PC 200 and the information input to the host PC 100). In addition, the host PC 100 executes all the substance processes so as to avoid mismatching of data for performing the processes. Thus, the system can be stably operated.

### Second Embodiment

Next, a substrate processing system 10 according to a second embodiment will be described. The second embodiment is different from the substrate processing system 10 according to the first embodiment which can display all the screen groups on the display 100MD of the host PC 100 regardless of the possession/non-possession of the operation right in that, if the operation right of a specific screen group is given to the slave PC 200, the specific screen group is not displayed on the display 100MD of the host PC 100. Accordingly, the substrate processing system 10 according to the present embodiment will be described concentrating on this difference.

(Operation Right Giving Process)

For example, if the operation request interrupt signal is transmitted from the slave PC 200a, the host PC 100 receives the operation request interrupt signal and starts the operation right giving process from a step 1700 of FIG. 17. In steps 1005 to 1025, similar to the first embodiment, the operation right of the PM1 screen group is given to the slave PC 200a which has requested the screen operation. Thereafter, the process progresses to a step 1705, in which the display unit 195 judges whether or not the PC (host PC 100) has the operation right of each of the screen groups.

At this time, the host PC 100 does not have the operation right of the PM1 screen group. Accordingly, the process progresses to a step 1710, in which the display unit 195 inhibits the PM1 screen group without the operation right from being displayed on the display 100MD of the host PC 100. Then, the process progresses to a step 1795 and the present process is finished.

Accordingly, as shown in FIG. 18, the screen groups other than the PM1 screen group are displayed on the display 100MD of the host PC 100, but the PM1 screen group is not displayed. Therefore, according to the present embodiment, the screen group of which the operation right is given to any slave PC 200 is not displayed on the display of the host PC 100 (and the other slave PCs 200). Accordingly, it is possible to prevent important information from flowing out by displaying the important information on the screen of the PC which does not have the operation right.

In the above-described embodiments, the operations of the units are associated with each other and may be replaced with a series of operations in consideration of the association. Thus, the embodiment of the host control device for controlling the giving of the screen operation right may be applied to the embodiment of the screen operation right giving method. In addition, the operations of the units of the host control device may be replaced with the processes of the units such that the embodiment of the host control device for controlling the giving the screen operation right is applied to the embodiment of the screen operation right giving program. In addition, the screen operation right giving program is stored in a computer-readable recording medium such that the embodiment of the screen operation right giving program is applied to the embodiment of the computer-readable recording medium having the program recorded thereon.

Although the exemplary embodiments of the present invention are described with reference to the accompanying drawings, the present invention is not limited to these embodiments. It will be apparent to those skilled in the art various kinds of modifications or changes may be made without departing from the scope of the invention as shown in the appended claims.

For example, the substrate used in the present invention is not limited to a glass substrate and, for example, a silicon wafer may be used. That is, the substrate used in the present invention may include, for example, a substrate used in an organic EL display, a plasma display, a Liquid Crystal Display (LCD) or the like. The substrate processing device according to the present invention may include a device capable of performing a desired process with respect to such a substrate.

In addition, the substrate processing device according to the present invention may include a coater developer, a cleaning device, a Chemical Mechanical Polishing (CMP) device, a Physical Vapor Deposition (PVD) device, an exposure device, an ion implanter, and so on, in addition to the etching device, the CVD device and so on. In addition, a thermal diffusion process or an ashing process may be executed in the substrate processing device according to the present invention.

### BRIEF DESCRIPTION OF THE DRAWINGS

FIG. 1 is a schematic view of a substrate processing system according to first and second embodiments of the present invention.

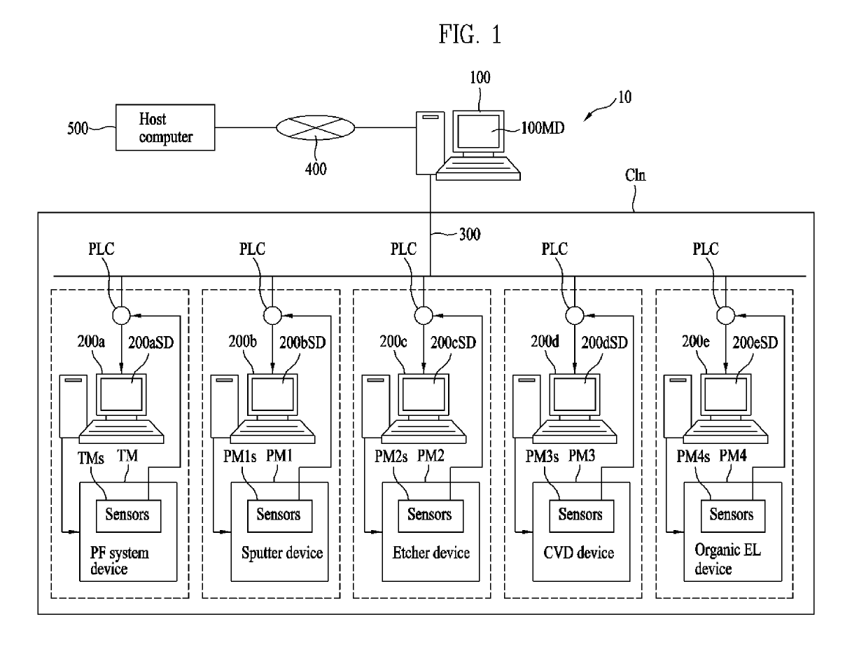

FIG. 2 is an arrangement view of devices in a clean room according to the first and second embodiments.

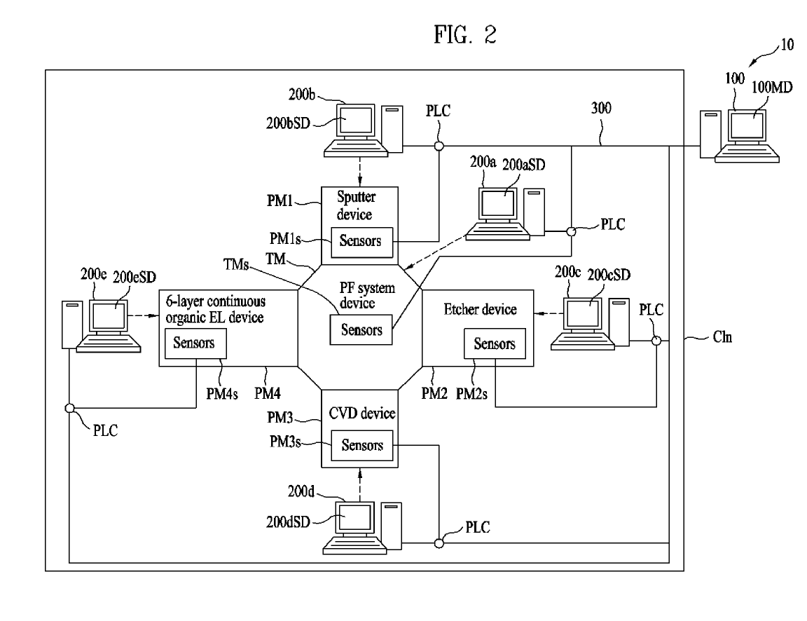

FIG. 3 is a longitudinal cross-sectional view of a process module PM2 according to the first and second embodiments of the present invention.

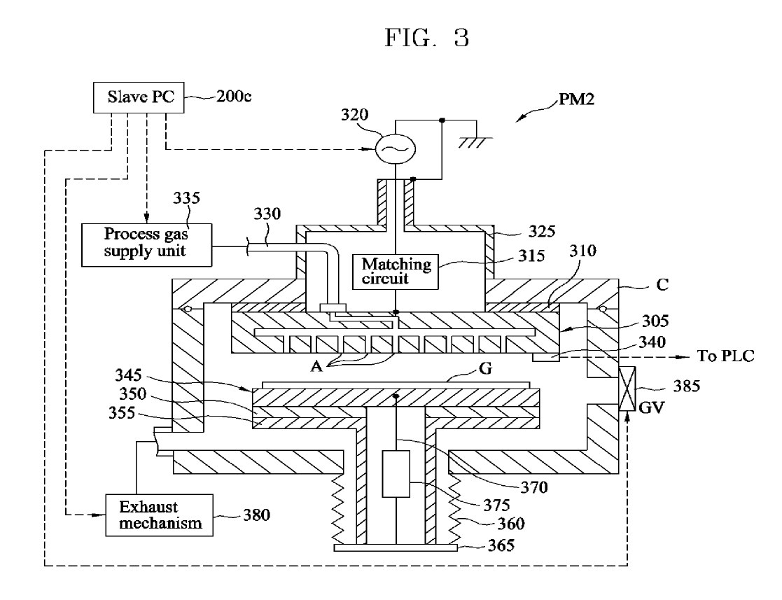

FIG. 4 is a perspective view of a process module PM4 according to the first and second embodiments of the present invention.

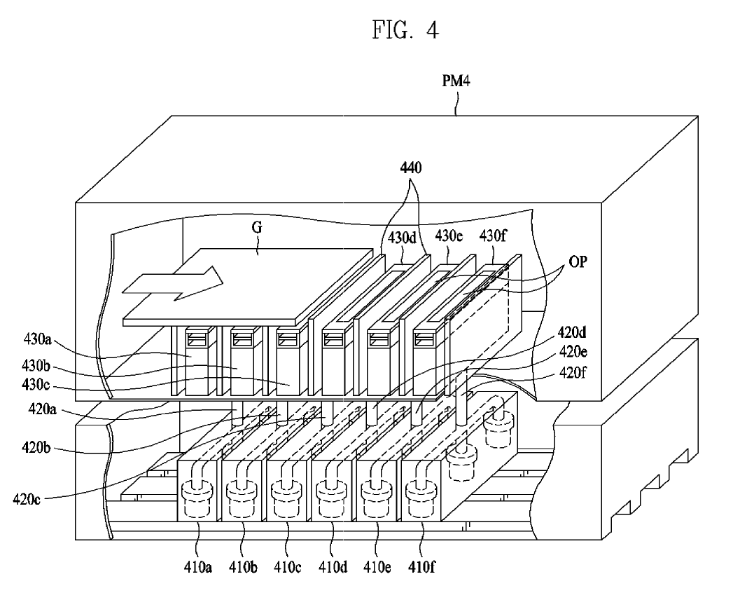

FIG. 5 is a hardware configuration view of a Personal Computer (PC) according to the first and second embodiments of the present invention.

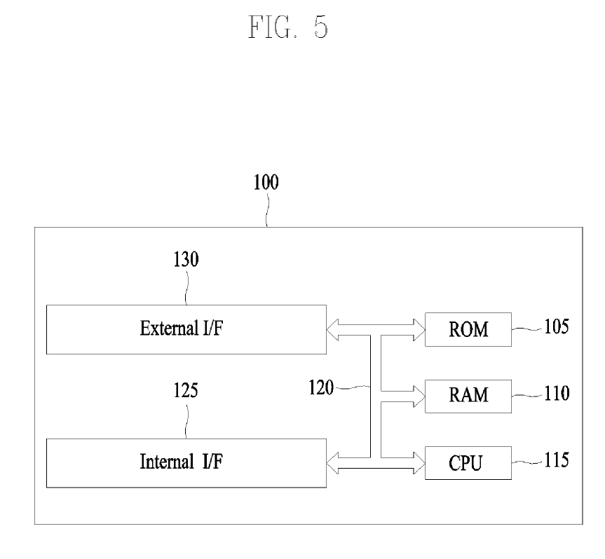

FIG. 6 is a functional configuration view of a host PC according to the first and second embodiments of the present invention.

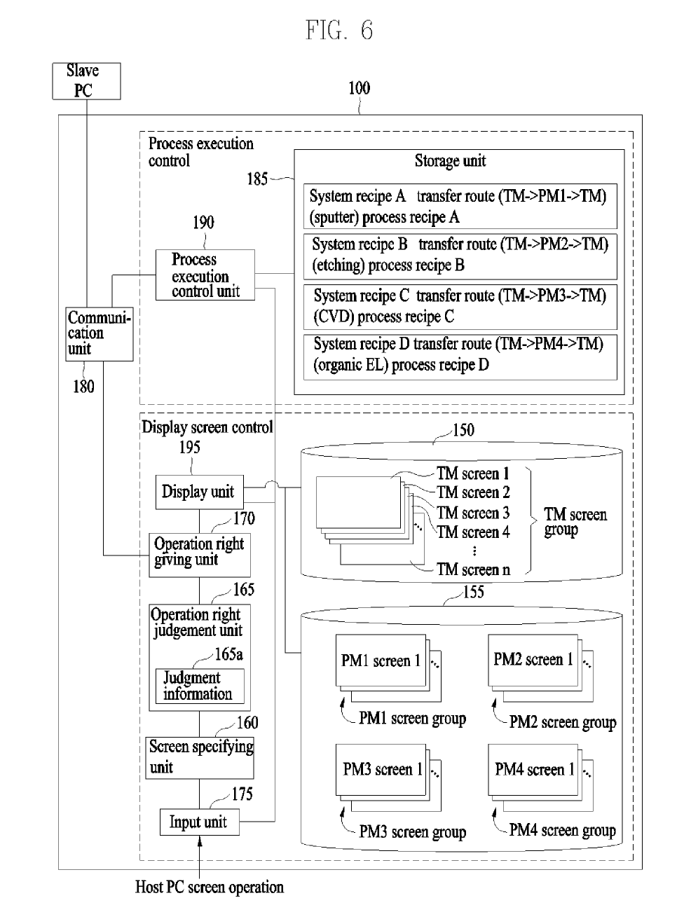

FIG. 7 is a functional configuration view of a slave PC according to the first and second embodiments of the present invention.

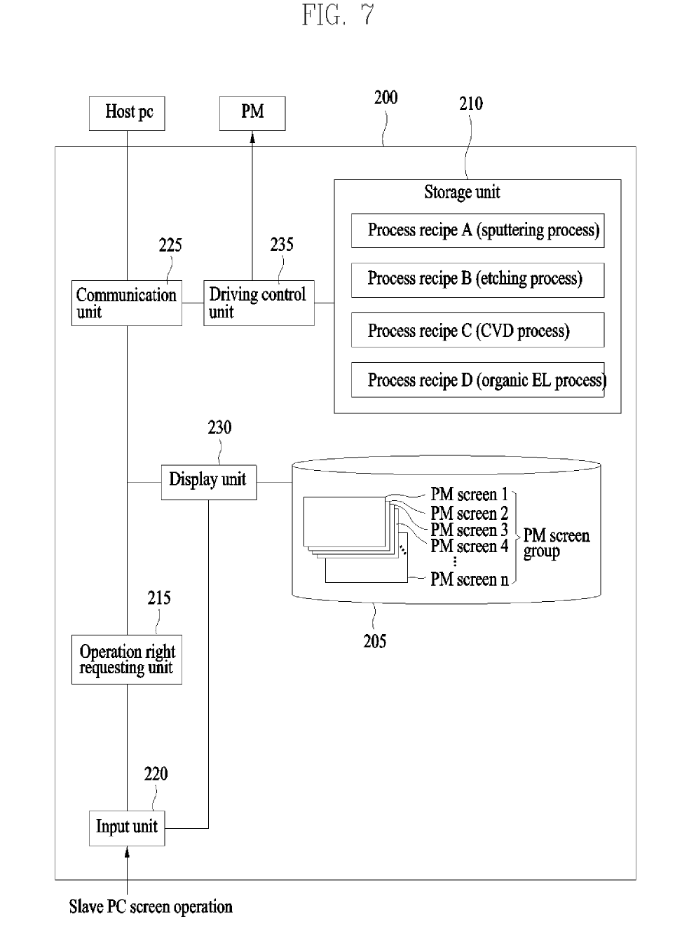

FIG. 8 is a view showing a portion of a process recipe C according to the first and second embodiments of the present invention.

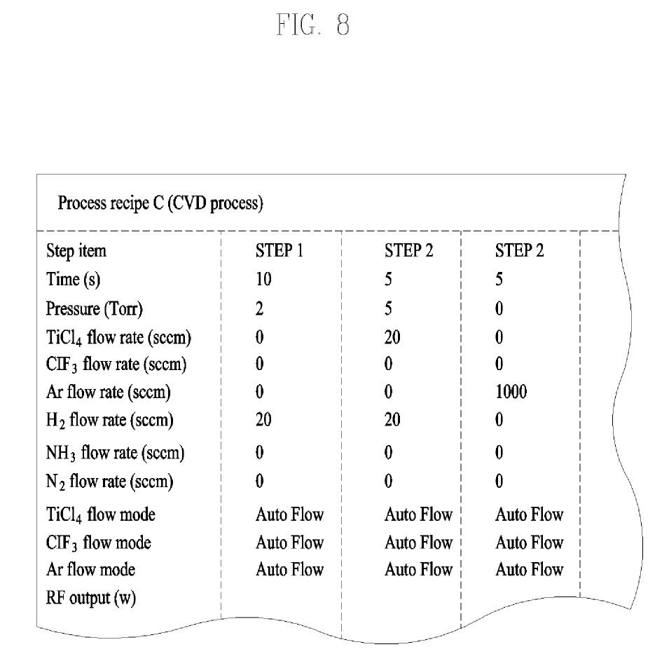

FIG. 9 is a flowchart showing an operation request interrupt process according to the first and second embodiments of the present invention.

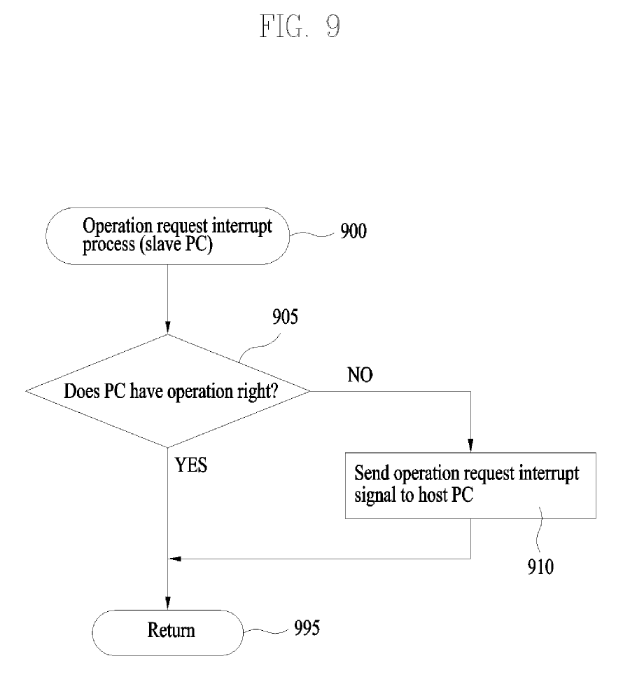

FIG. 10 is a flowchart showing an operation right giving process according to the first embodiment of the present invention.

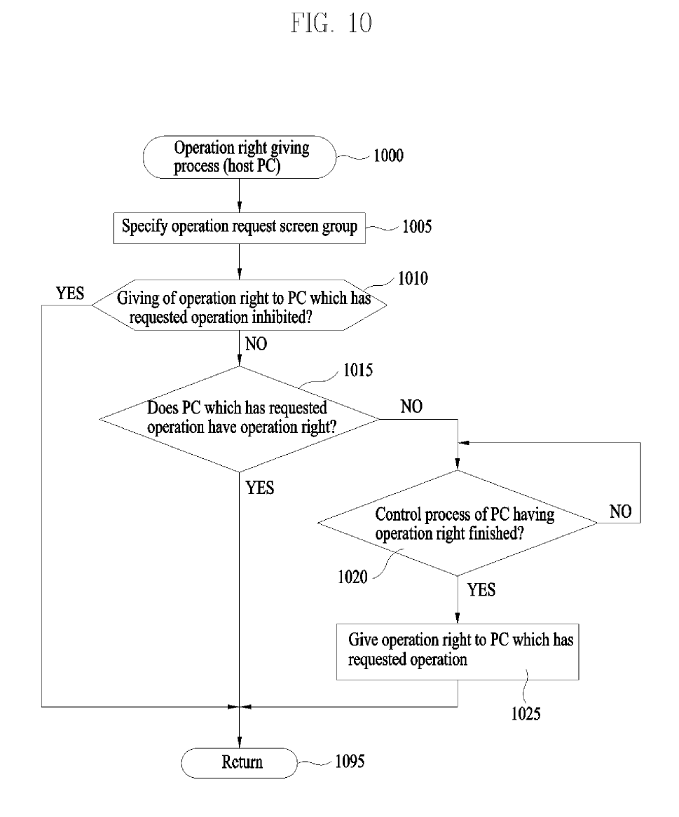

FIG. 11 is a view showing an example of a screen for displaying existence/non-existence of an operation right on a display of a host PC according to the first and second embodiments of the present invention.

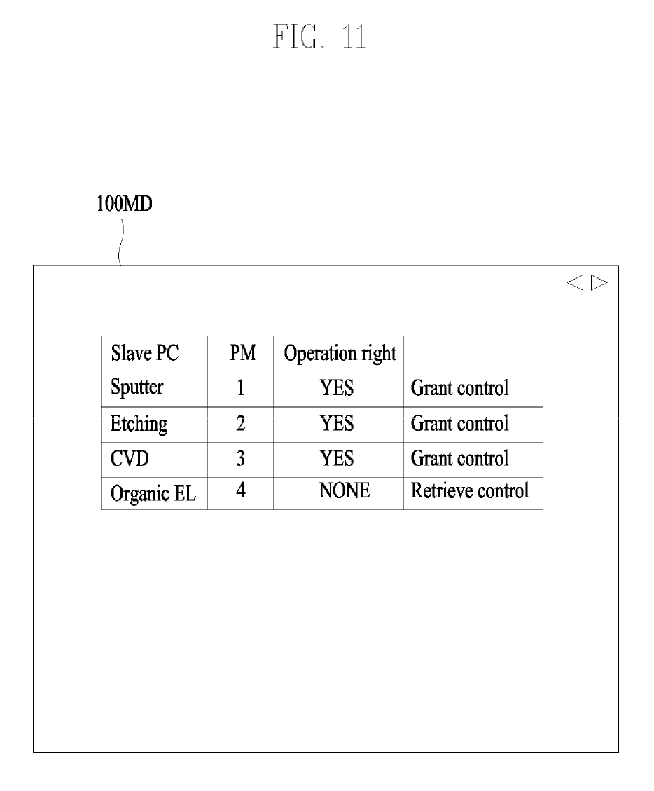

FIG. 12 is a view showing an example of a screen for displaying an operation right on a display of a PC according to the first and second embodiments of the present invention.

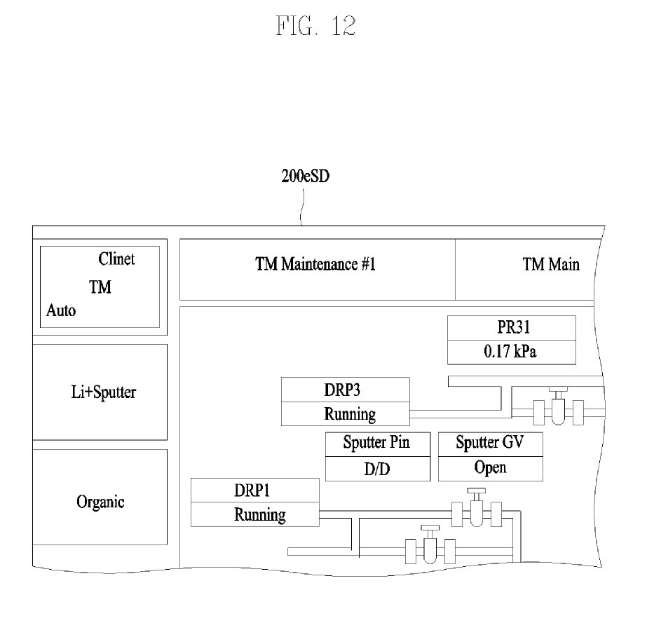

FIG. 13 is a flowchart showing a process execution control information input process according to the first and second embodiments of the present invention.

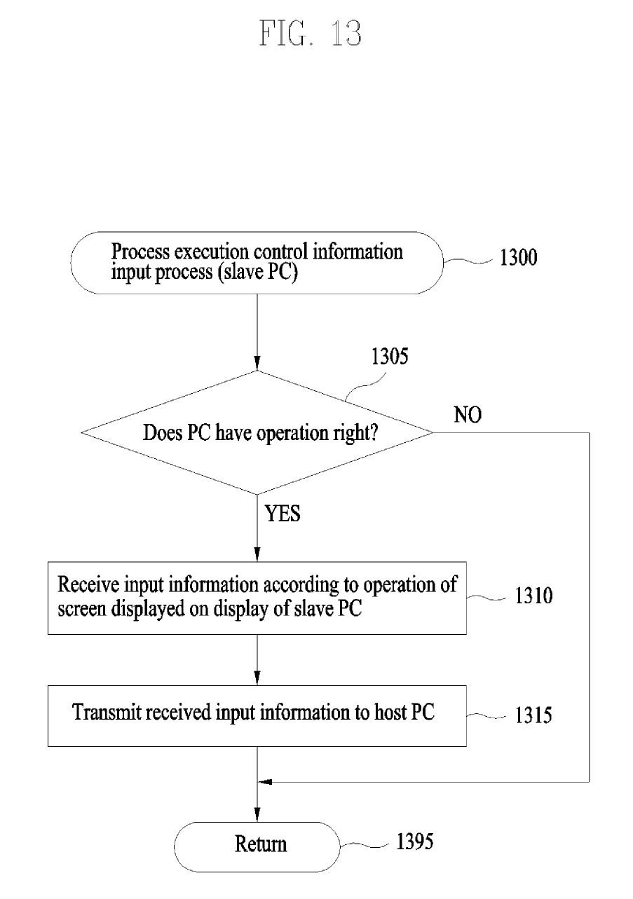

FIG. 14 is a flowchart showing a process execution control process according to the first and second embodiments of the present invention.

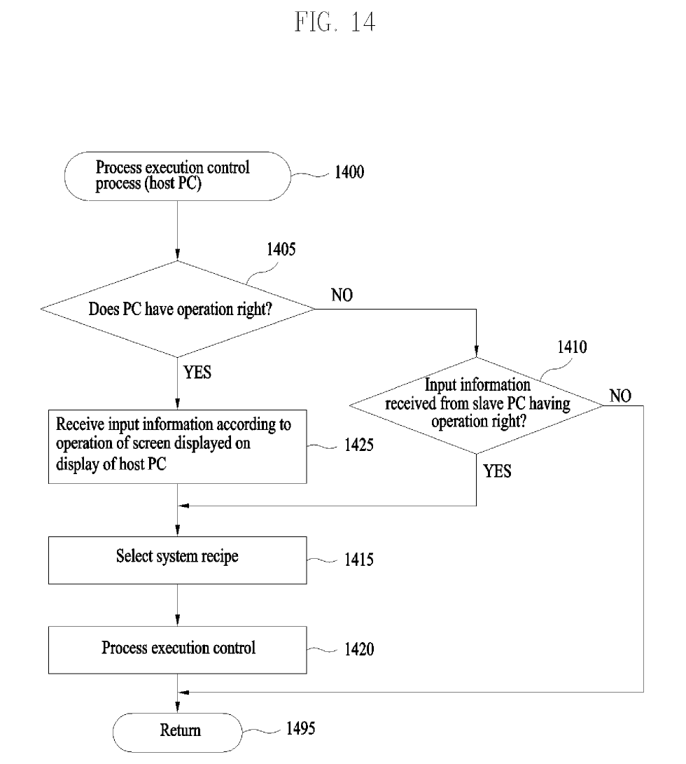

FIG. 15 is a flowchart showing a driving control process according to the first and second embodiments of the present invention.

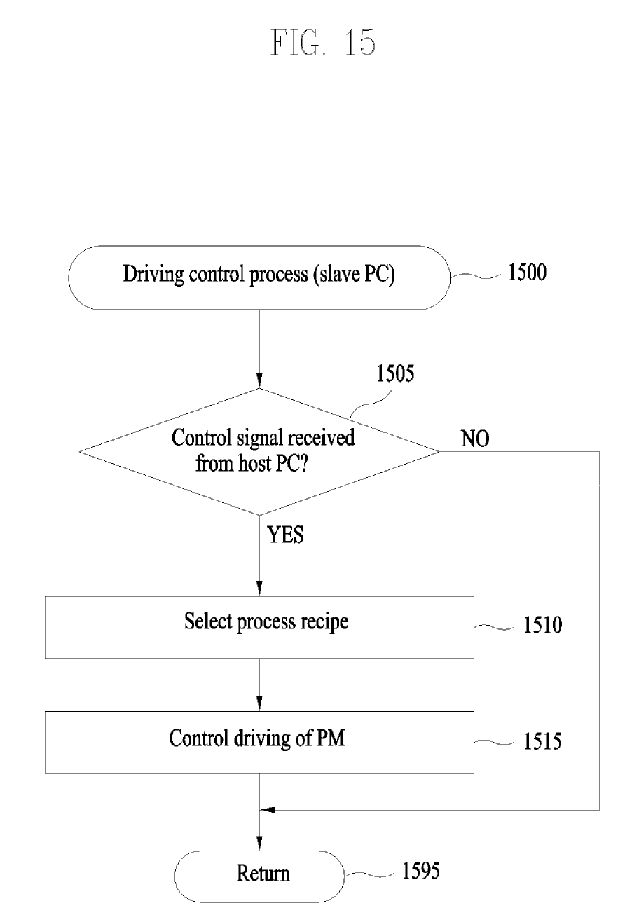

FIG. 16 is a view explaining a relationship between a simultaneous operation and exclusive control and the modularization of processes according to the first embodiment of the present invention.

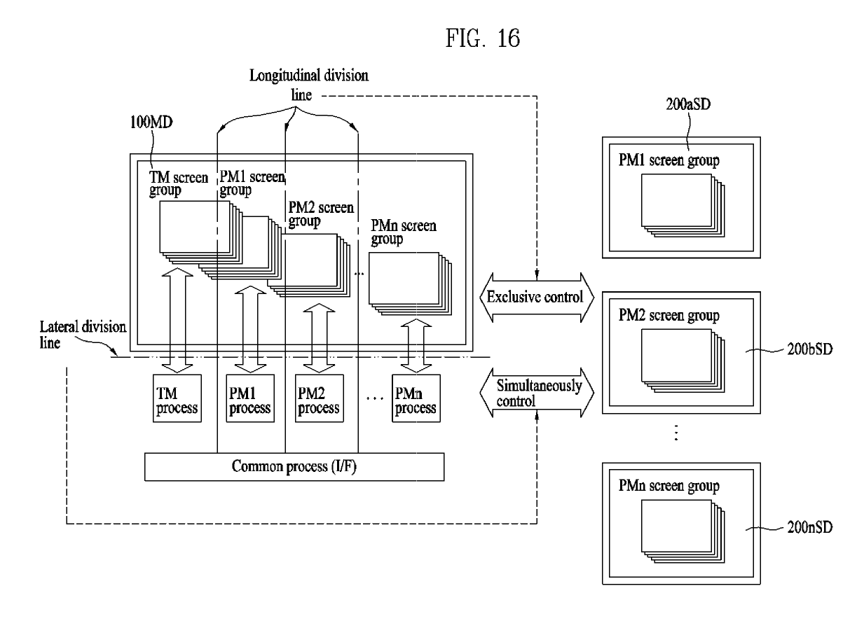

FIG. 17 is a flowchart showing an operation right giving process according to the second embodiment of the present invention.

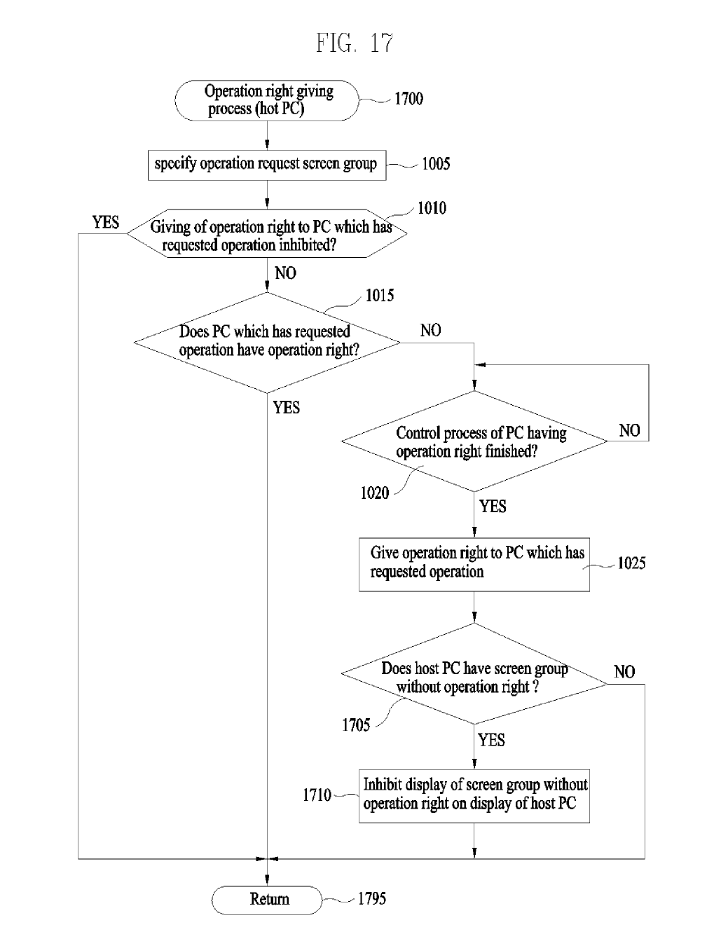

FIG. 18 is a view explaining a screen display according to the second embodiment of the present invention.

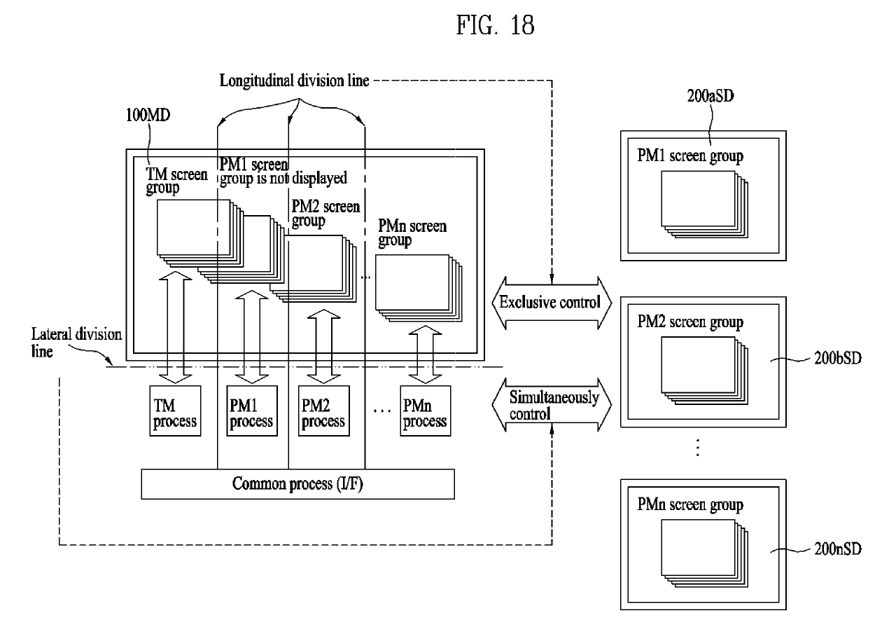

1. A host control device which is connected to a first slave control device including a display unit for displaying a screen group for operating a substrate processing device and a second slave control device including a display unit for displaying a screen group for operating a transfer device via a network, includes a display unit for displaying the screen group displayed on the display unit of the first slave control device and the screen group displayed on the display unit of the second slave control device, and controls the first slave control device and the second slave control device, the device comprising:
a screen database storing the screen group displayed on the display unit of the first slave control device and the screen group displayed on the display unit of the second slave control device;
a screen specifying unit specifying a screen group, of which the operation is requested, from a plurality of screen groups stored in the screen database, according to the request for a screen operation transmitted from either the first slave control device or the second slave control device;
an operation right judgment unit judging whether or not the operation right of the screen group specified by the screen specifying unit is given to the requesting slave control device; and
an operation right giving unit giving the operation right of the specified screen group to the requesting slave control device without changing devices to which the operation rights of screen groups other than the specified screen group are given, in order to allow different control devices of a plurality of control devices including the first slave control device, the second slave control device and the host control device to simultaneously and separately operate different screen groups, if it is judged that the operation right of the screen group is given to the requesting slave control device by the operation right judgment unit.

2. The host control device according to claim 1, wherein the operation right judgment unit judges that the operation right of the specified screen group is given to the requesting slave control device after a process which is being executed by the control device to which the operation right is given is finished, if the operation right of the specified screen group is given to a control device other than the requesting slave control device in the plurality of control devices.

3. The host control device according to claim 2, wherein the operation right judgment unit judges that the requested operation right of the screen group is given to the host control device after a process which is being executed by any one of the slave control devices is finished, if the operation right of the screen group of which the operation is requested by the host control device is given to any one of the slave control devices.

4. The host control device according to claim 3, wherein the operation right judgment unit judges that the requested operation right of the screen group is sequentially given from a control device having a highest priority of the plurality of control devices according to predetermined priorities, if the operation of the same screen group is requested by the plurality of control devices.

5. The host control device according to claim 1, wherein the operation right judgment unit judges whether or not the giving of the operation right to the control device which has requested the operation is inhibited in advance, and judges that the operation right is not given to the control device which has requested the operation if the giving of the operation right is inhibited.

6. The host control device according to claim 3, further comprising:
an input unit receiving information which is input using the screen displayed on the display unit of the host control device to which the operation right is given, if the operation right is given to the host control device by the operation right giving unit;
a communication unit receiving information, which is input using the screen displayed on the display unit of the slave control device to which the operation right is given, from the slave control device to which the operation right is given, if the operation right is given to any one of the slave control devices by the operation right giving unit;
a storage unit storing recipes defining a plurality of substrate processing procedures executed by the substrate processing device; and
a process execution control unit executing a predetermined process executed based on the information received by the communication unit concurrently with another predetermined process executed based on the input information received by the input unit, based on the recipes stored in the storage unit.

7. The host control device according to claim 6, wherein the display unit of the host control device updates the contents of the screen displayed on the display unit of the host control device so as to keep a matching property with the contents of the screen displayed on the display unit of the slave control device to which the operation right is given, based on the information received by the communication unit in correspondence with the input operation to the screen displayed on the display unit of the slave control device to which the operation right is given.

8. The host control device according to claim 6, wherein the display unit of the host control device does not display the screen group if the operation right is given to any one of the slave control devices and the screen group of which the operation right is given is inhibited from being displayed on the display unit of the host control device in advance.

9. The host control device according to claim 6, wherein:
the host control device is connected to a plurality of first slave control devices for controlling a plurality of substrate processing devices and is connected to the second slave control device for controlling a transfer device for transferring the substrate adjacent to the plurality of substrate processing devices,
the screen database manages a plurality of screen groups displayed on the display units of the plurality of first slave control devices and the screen group displayed on the display unit of the second slave control device according to the screen groups,
the storage unit manages the plurality of substrate processing procedures executed by the plurality of substrate processing devices according to the recipes,
the operation right giving unit gives the operation right of the screen to any one of the plurality of control devices according to the screen groups managed by the screen database, and allows different control devices to simultaneously and separately operate different screen groups, and
the process execution control unit exclusively and concurrently controls the plurality of substrate processes executed by the plurality of substrate processing devices based on the recipes managed by the storage unit.

10. The host control device according to claim 9, wherein:
the plurality of first slave control devices are disposed in the vicinities of the plurality of substrate processing devices in a room in which the plurality of substrate processing devices are disposed,
the second slave control device is disposed in the vicinity of the transfer device disposed adjacent to the plurality of substrate processing devices in the same room as the room in which the plurality of substrate processing devices are disposed, and
the host control device is disposed outside the room so as to transmit or receive information to or from the slave control devices such that the plurality of substrate processes executed by the plurality of substrate processing devices and the transfer process executed by the transfer device are controlled and the giving of the operation right of the screen group displayed on the display unit of each slave control device is controlled.

11. A slave control device which is connected to a host control device for controlling an operation right of a screen via a network and includes a display unit for displaying either a screen group for operating a substrate processing device or a screen group for operating a transfer device, the device comprising:
a screen database storing the screen group displayed on the display unit of the slave control device;
an operation right requesting unit generating information for requesting the operation right of the screen group stored in the screen database; and
a communication unit transmitting the operation right request information generated by the operation right requesting unit to the host control device so as to request the operation of the screen and transmitting information, which is input using the display screen of the slave control device to which the operation right is given, to the host control device if the operation right of the screen group of which the operation is requested is given to the slave control device by the host control device, without changing devices to which the operation rights of screen groups other than a screen group specified according to the transmitted operation right request information are given,
wherein a predetermined process executed based on the information transmitted from the slave control device to which the operation right is given is executed by the host control device concurrently with another predetermined process executed based on the information input using the screen displayed on a display unit of the host control device.

12. A screen operation right giving method using a host control device which is connected to a first slave control device including a display unit for displaying a screen group for operating a substrate processing device and a second slave control device including a display unit for displaying a screen group for operating a transfer device via a network, includes a display unit for displaying the screen group displayed on the display unit of the first slave control device and the screen group displayed on the display unit of the second slave control device, and controls the first slave control device and the second slave control device, the method comprising:
storing the screen group displayed on the display unit of the first slave control device and the screen group displayed on the display unit of the second slave control device in a screen database;
specifying a screen group, of which the operation is requested, from a plurality of screen groups stored in the screen database, according to a request for the operation of the screen transmitted from either the first slave control device or the second slave control device;
judging whether or not the operation right of the specified screen group is given to the requesting slave control device; and
giving the operation right of the specified screen group to the requesting slave control device without changing devices to which the operation rights of screen groups other than the specified screen group are given, in order to allow different control devices of a plurality of control devices including the first slave control device, the second slave control device and the host control device to simultaneously and separately operate different screen groups, if it is judged that the operation right of the screen group is given to the requesting slave control device.

13. A storage medium containing a screen operation right giving program for executing a process of giving an operation right of a screen on a computer using a host control device which is connected to a first slave control device including a display unit for displaying a screen group for operating a substrate processing device and a second slave control device including a display unit for displaying a screen group for operating a transfer device via a network, includes a display unit for displaying the screen group displayed on the display unit of the first slave control device and the screen group displayed on the display unit of the second slave control device, and controls the first slave control device and the second slave control device, the screen operation right giving program executing on the computer a method comprising:
storing the screen group displayed on the display unit of the first slave control device and the screen group displayed on the display unit of the second slave control device in a screen database;
specifying a screen group, of which the operation is requested, from a plurality of screen groups stored in the screen database, according to a request for the operation of the screen transmitted from either the first slave control device or the second slave control device;
judging whether or not the operation right of the specified screen group is given to the requesting slave control device; and
giving the operation right of the specified screen group to the requesting slave control device without changing devices to which the operation rights of screen groups other than the specified screen group are given, in order to allow different control devices of a plurality of control devices including the first slave control device, the second slave control device and the host control device to simultaneously and separately operate different screen groups, if it is judged that the operation right of the screen group is given to the requesting slave control device.
